(19) United States
(12) Patent Application Publication
(10) Pub. No.: US 2006/0092904 A1
(43) Pub. Date: May 4, 2006

(54) Generation of data session records for mobile data communications networks

(76) Inventor: Douglas John Carson, Edinburgh (GB)

Correspondence Address: Paul D. Greeley, Esq.;Ohlandt, Greeley, Ruggiero & Perle, L.L.P., 10th Floor, One Landmark Square, Stamford, CT, 06901-2682, US

(21) Appl. No.: 11/012,514

(22) Filed: Dec. 15, 2004

(30) Foreign Application Priority Data
Oct. 28, 2004 (GB) 04 23 907.5

(51) Int. Cl. H04B 7/216

(52) U.S. Cl. 370/342; 370/335

(57) ABSTRACT

Transaction detail records for a mobile data service are assembled by: de-multiplexing signalling sessions carried on a signalling channel and selecting a signalling session related to a mobile data service; using information from the selected signalling session to identify data sessions associated with the mobile data service; using information from the selected signalling session to obtain information related to the mobile data service from an authentication, authorisation and accounting (AAA) resource; and assembling information relating to the identified data sessions and information obtained from the resource to provide a transaction detail record.

This invention relates to generation of data session records for mobile data communications networks, such as (though not exclusively) networks operating according to the CDMA 2000 standard.

### BACKGROUND ART

The continuing expansion in demand for mobile communications services, and for more complex services requiring higher communications bandwidths, has resulted in proposals for new generations of mobile communication technologies and protocols. Furthermore, intensifying competition among providers of such services has resulted in increased emphasis on differentiation among service providers based on quality of service, and thus led to a requirement for monitoring performance of equipment used to provide these services.

One new-generation technology currently being developed and introduced is CDMA 2000. This technology and services which incorporate it are being defined by working groups of the 3^{rd} Generation Partnership Project 2 (3GPP2) in documents available via that organisation's website at www.3gpp2.org. For example, 3GPP2 specification A.S0017, Interoperability Specification (IOS) for CDMA 2000 Access Network Interfaces—Part 7 (A10 and A11 Interfaces), defines a standard for interfacing one or more Packet Data Serving Nodes (PDSNs) with one or more Packet Control Functions (PCFs), to facilitate reliable use of Internet Protocol (IP) packet data technology over a mobile communications link (Wireless IP).

In order to provide reliable implementations of this technology, telecommunications service providers need to be able to monitor the status and operation of networks incorporating it. This enables the service provides to ensure that contracted levels of quality of service (QoS) are being provided, and to detect and remedy instances where the contracted levels are not being met. In addition, monitoring information enables the service providers to ensure that users and other operators are correctly billed for the value of services used (revenue assurance).

Current proposals for monitoring CDMA 2000 services involve the use of tasks (implemented as software programs) running on the network's switching equipment. Disadvantages of this approach include lack of visibility into the details of message sequencing, lack of detail on messages exchanged, heavy loading on switch, low frequency of information updates and a network-element rather than an overall network viewpoint.

### DISCLOSURE OF INVENTION

According to one aspect of this invention there is provided a method of assembling a transaction detail record for a mobile data service, provision of said service involving a communications path carrying at least one signalling channel and a plurality of data channels, and also involving a resource for providing at least one of authentication, authorisation and accounting, comprising:

de-multiplexing signalling sessions carried on said signalling channel and selecting a signalling session related to a mobile data service;

using information from the selected signalling session to identify data sessions associated with the mobile data service;

using information from the selected signalling session to obtain information related to the mobile data service from the resource; and

assembling information relating to the identified data sessions and information obtained from the resource to provide a transaction detail record.

According to another aspect of this invention there is provided apparatus for assembling a transaction detail record for a mobile data service, provision of said service involving a communications path carrying at least one signalling channel and a plurality of data channels, and also involving a resource for providing at least one of authentication, authorisation and accounting, comprising:

a de-multiplexer for de-multiplexing signalling sessions carried on said signalling channel and selecting a signalling session related to a mobile data service;

a session identifier for using information from the selected signalling session to identify data sessions associated with the mobile data service;

a resource query means for using information from the selected signalling session to obtain information related to the mobile data service from the resource; and

an assembler for assembling information relating to the identified data sessions and information obtained from the resource to provide a transaction detail record.

### BRIEF DESCRIPTION OF DRAWINGS

A method and apparatus in accordance with this invention, for assembling a transaction detail record for a CDMA 2000 mobile data service, will now be described, by way of example, with reference to the accompanying drawings, in which:

FIG. 1 is a block schematic diagram of a network configured to enable a wireless mobile device to access data services over a wireless network and using IP;

FIGS. 2 and 3 are examples of transaction sequences involved in establishing wireless IP communications sessions;

FIG. 4 shows data structures used by the process of FIGS. 5A and 5B;

FIGS. 5A and 5B together show a flow diagram of a process in accordance with the invention for creating transaction detail records of data transactions on the network shown in FIG. 1; and

FIG. 6 shows the format of a wireless IP transaction detail record.

### DETAILED DESCRIPTION

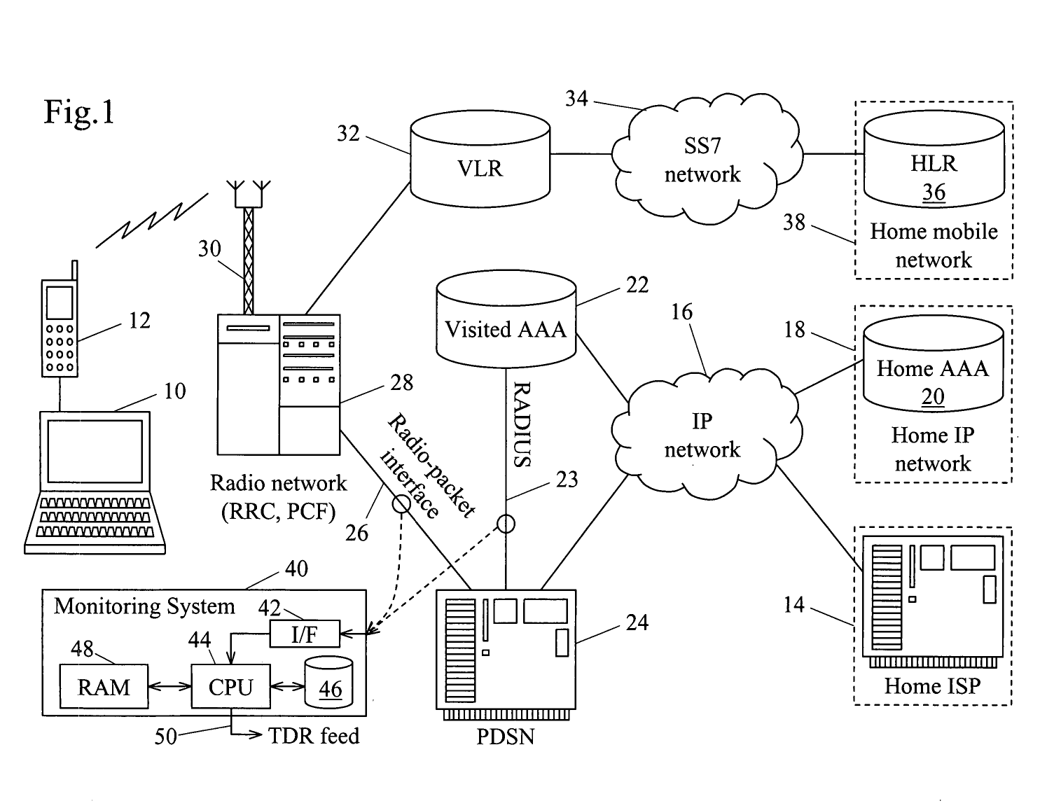

Referring to FIG. 1, a data user has a data terminal 10, such as a laptop computer, coupled to a wireless interface device such as a mobile telephone 12, and wishes to access data resources provided by a home internet serviced provider (ISP) 14 with which the user is registered. The home ISP 14 forms part of an overall IP network 16 which also includes other portions of the user's home IP network 18, in particular containing a home Authentication, Authorization and Accounting (AAA) node 20. The geographic region in which the user is currently located is served by a visited AAA 22, coupled via a Remote Authentication Dial-In User Service (RADIUS) interface 23 to a public data switched network (PDSN) 24. Both the visited AAA 22 and the PDSN 24 are coupled into the IP network 16. The PDSN 24 is connected by a link 26 to a radio network (RN) infrastructure 28, that includes Radio Resource Control (RRC) and PCF modules and a base station 30 for providing wireless contact with the mobile telephone 12. The radio network 28 and the PDSN 24 provide a connection through the public data network 16 to the user's home network 18. The network 28 is also connected to a Visitor Location Register (VLR) 32 in turn coupled via an SS7 telecoms signalling network 34 to a Home Location Register (HLR) 36 in the user's home mobile telephone network 38, to gain subscriber information from the home network.

The link 26 between the radio network 28 and the PDSN 24 provides a radio-packet (R-P) interface, where the radio-dependent part of the network connects with the packet data network elements. This interface is responsible for maintaining the logical connection to support the user's data access activities, even when no data packets are currently being passed between the mobile telephone 12 and the home network 18. If the mobile telephone 12 moves to another radio network coupled to the PDSN 24, the R-P session is transferred to the new network. If the mobile telephone 12 moves to another PDSN altogether, a new R-P session is established. The mobile telephone 12 and the PDSN 24 establish a Point-to-Point Protocol (PPP) link after the radio network 28 and the PDSN 24 have established the R-P session. User data is transported by means of the Generic Routing Encapsulation (GRE) protocol (defined in the Internet Engineering Task Force's RFCs 1701, 2784 and 2890), coordinated by a so-called A10 connection that is established by the PCF (in the RN 28) and the PDSN 24 and that identifies the participating PCF and PDSN (by their IP addresses). This A10 connection is established, maintained and released by the exchange between the PCF and the PDSN 24 of so-called A11 messages, the format of which is specified in the above-identified 3GPP2 document. The PCF and the PDSN 24 maintain an association between the A10 connection and the mobile telephone's International Mobile Subscriber Identity (IMSI).

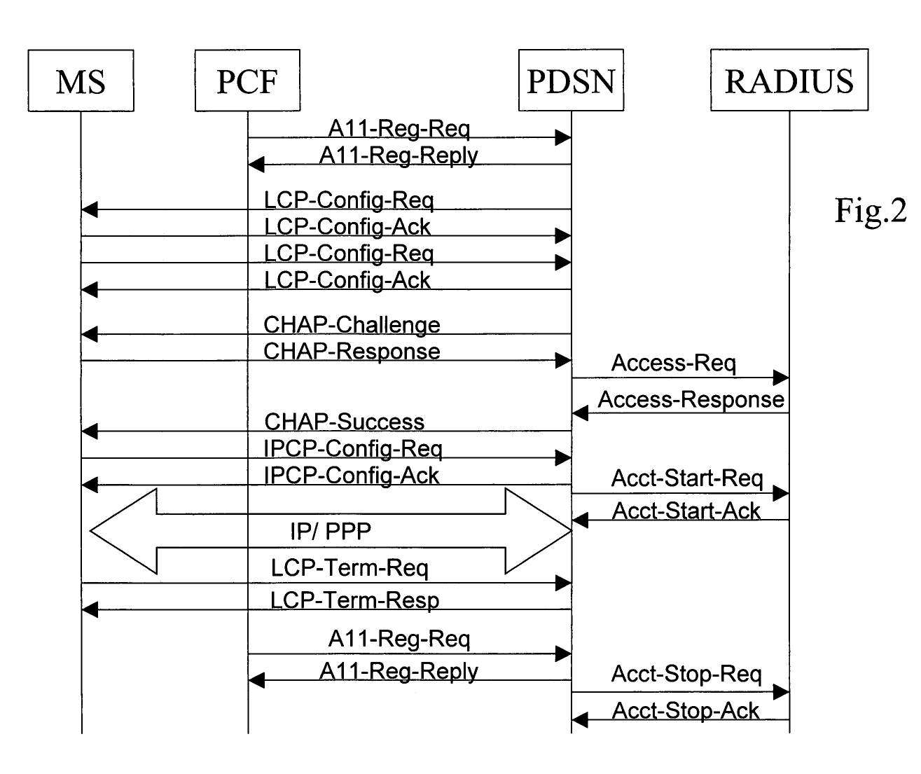

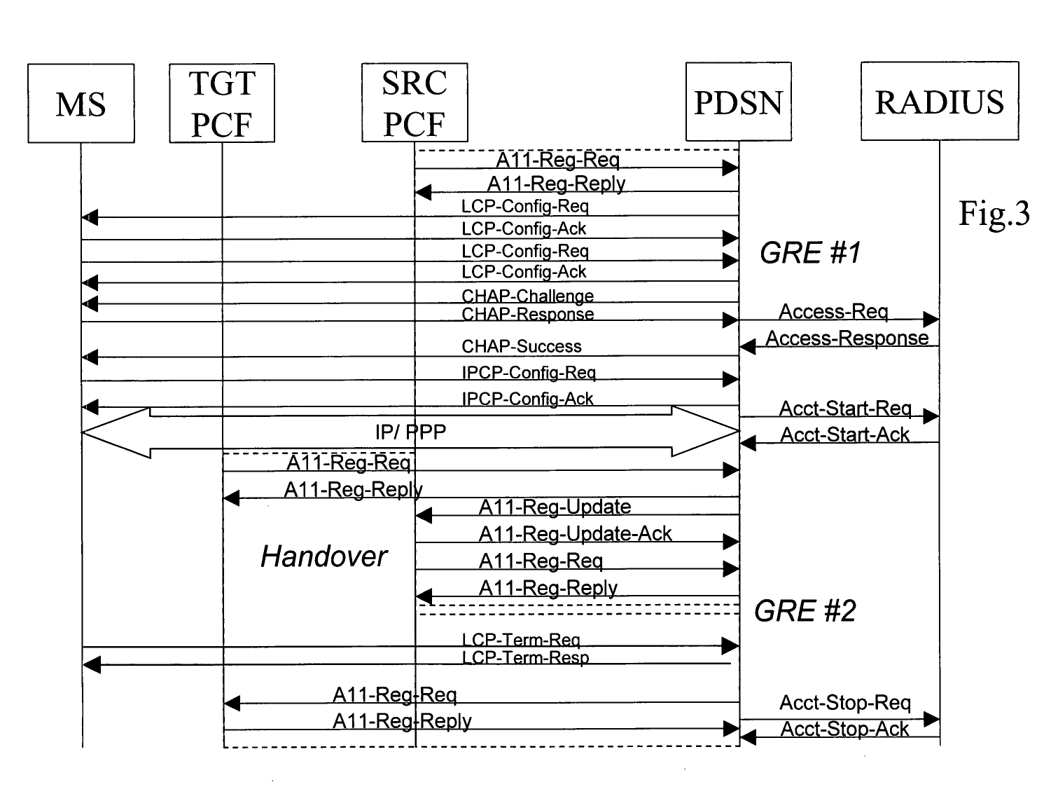

FIG. 2 shows an example of the sequence of messages exchanged between the PCF, the PDSN 24, the mobile telephone (MS) 12 and a Remote Authentication Dial-In User Service (RADIUS) server to establish and manage a simple wireless IP session. FIG. 3 shows the corresponding message sequence for the more complex case of a session in which a handover occurs (as a result of the user's movement) from a “source” PCF (SRC PCF) with which the session commences to a “target” PCF (TGT PCF) to which the session is handed over. This second example entails the use of two Generic Routing Encapsulations (GRE#1 and GRE#2).

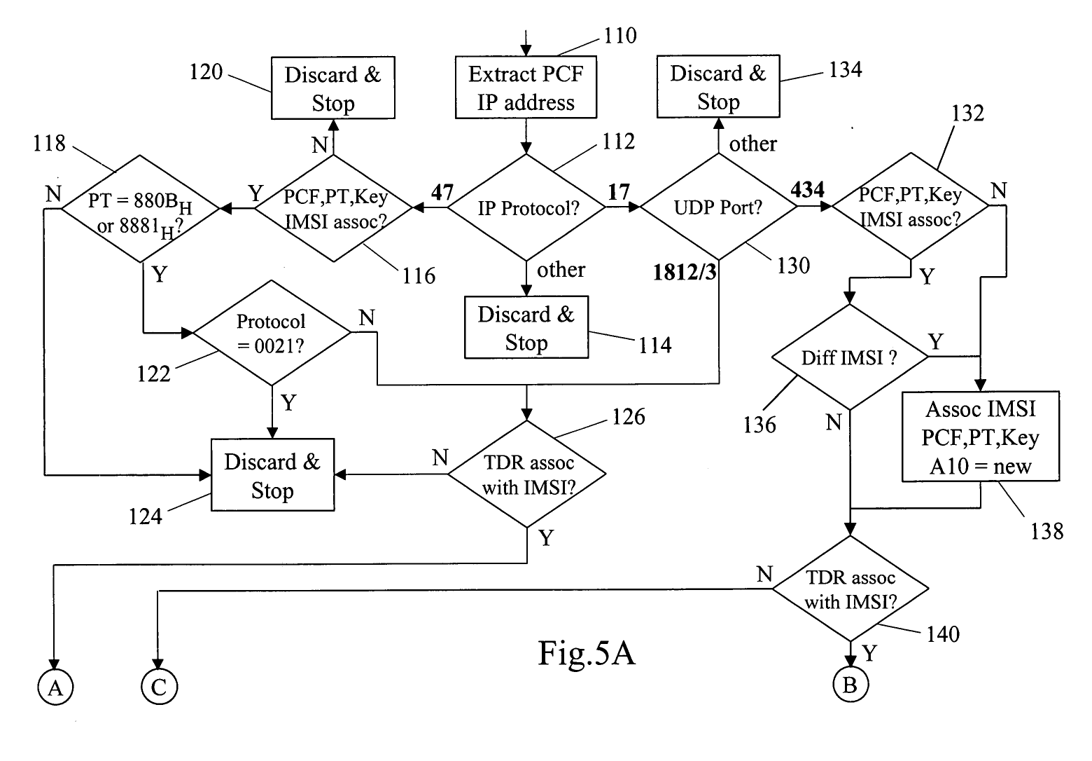

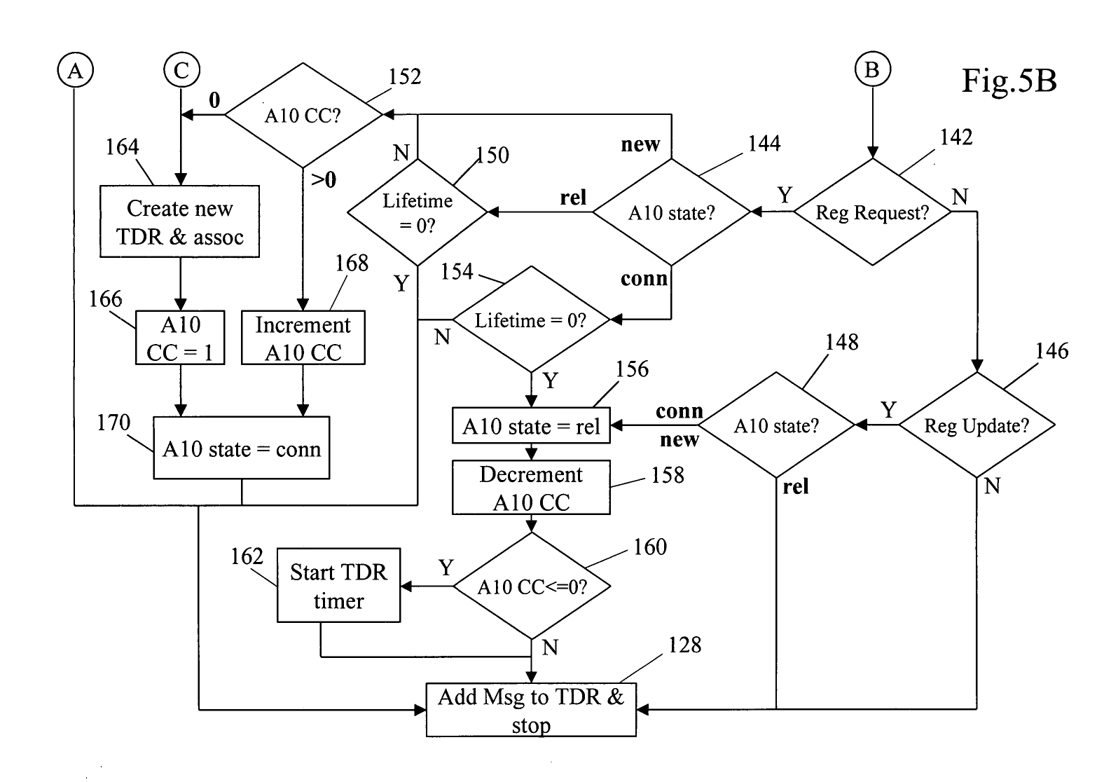

FIGS. 5A and 5B together show a procedure for analysing A11 messages to assemble in accordance with this invention respective transaction detail records (TDRs) for wireless IP transactions conducted in the system illustrated in FIG. 1.

To this end (referring still to FIG. 1) a monitoring system 40 is provided for passively monitoring the RADIUS interface link 23 and the link 26 carrying A11 messages between the PCF and the PDSN 24. In an actual installation it may be necessary to monitor multiple links, for example between the PDSN 24 and multiple radio networks 28 and multiple PCFs in a network. The monitoring is passive in the sense that the operation of the links 23 and 26 is undisturbed by the presence of the monitoring system 40, which simply makes copies of some or all of the message packets it observes traversing the links. The system 40 is coupled to the links 23 and 26 in such a way that the operating characteristics of the links are not altered. In the case of an optical link, for example, the coupling may comprise an optical power splitter and for an electrical link it may be a bridging isolator.

The monitoring system 40 has an input interface 42 which receives and conditions the signals received from the coupling to the links 23 and 26, and supplies them to a processor/CPU 44 operating under the control of software program instructions in a program store 46 and using a random access store 48. The processor 44 extracts messages from the signals and performs some initial processing (e.g. error checking and preliminary decoding). The messages are subsequently analysed by the processor 44 in accordance with the program instructions, as described below, to provide a data feed 50 of (TDRs) to other applications (not shown), or alternatively may be forwarded via a communications link (e.g. a local area network, not shown) to a control centre (not shown) for further analysis and generation of TDRs. The apparatus for coupling to the links 23 and 26, and for extracting and storing messages contained in the signals obtained from the links, may comprise for example components of acceSS7 system equipment available from Agilent Technologies for monitoring messages traversing SS7 networks.

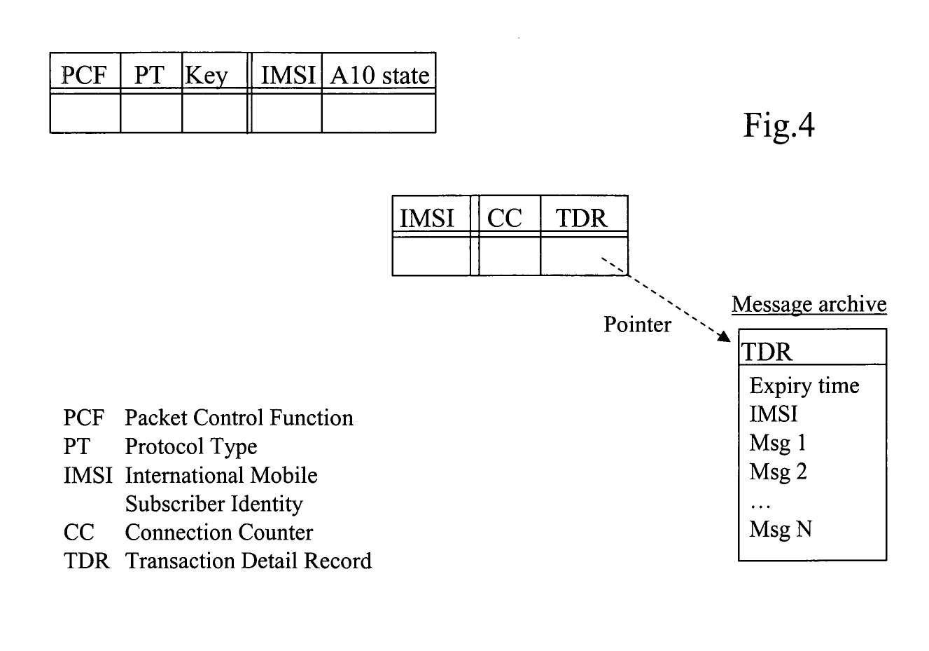

Referring to FIG. 4, the procedure for analysing the monitored A11 messages involves the maintenance of two associations between parameters contained in the monitored messages, and illustrated by the data structures shown in FIG. 4:
PCF/PT/KEY→IMSI, A10 state: The triple of PCF node IP address (or RADIUS server IP address), GRE protocol-type field and GRE protocol key is uniquely mapped to an IMSI and an indication of the A10 connection state.
IMSI A10 CC, TDR reference: An IMSI is uniquely mapped to a counter holding the number of established A10 connections and a reference to a TDR.
   These data structures may be implemented, for example, as tables held in the random access store 48 (FIG. 1).

Referring to FIG. 5A, the procedure for analysing the monitored messages operates as described below with reference to the numbered operations and decision points.

Step 110: The IP address of the node sending a message to or receiving a message from a PDSN is extracted. The IP address of the PDSN is already known so the source address is extracted when the destination address is recognised as being the PDSN address, and vice-versa.

Step 112: The IP protocol field is checked and if the protocol is User Datagram Protocol (UDP—protocol number 17) then the message is passed to step 128 for processing. If the protocol is GRE (number 47) then the message is passed to step 116 for processing; otherwise the message is discarded (step 114). IP protocol numbers are assigned by the Internet Assigned Numbers Authority (IANA), and are published at http://www.iana.org/assignments/protocol-numbers.

Step 116: The protocol type (PT) and protocol key are extracted from the GRE header and these are used in conjunction with the PCF address (extracted in step 110) to query the association of PCF/PT/KEY→IMSI. If an IMSI is already associated with the PCF/PT/KEY triple then processing proceeds at step 118, for the data session thus identified as being associated with a mobile data service; otherwise the message is discarded (step 120).

Step 118: A check is made as to whether the protocol type of the GRE encapsulated frame is PPP (hexadecimal value 880B or 8881). PPP frames are passed to step 122 for processing as described below, and are otherwise discarded (step 124). This process can be extended if desired to accommodate protocols additional to PPP, by inserting protocol-specific tests and procedures at this point. Protocol types are defined by IANA, and are published at http://www.iana.org/assignments/ethernet-numbers.

Step 122: The protocol number of the PPP frame is examined and provided the PPP frame does not contain an IP frame (protocol number 0021) then the message is passed for further processing at step 126, described below; otherwise it is discarded (step 124). This procedure may be adjusted if it is not required to discard content: for example in some scenarios the IP content may be passed on if the IMSI matches a target list. Similarly for troubleshooting it may be necessary to capture the first few messages of the content stream to identify connectivity problems. PPP protocol numbers are assigned by IANA, and published at http://www.iana.org/assignments/ppp-numbers.

Step 126: A check is made to ensure that there is a target TDR to which the message can be appended. If there is no TDR associated with the IMSI then the message is discarded (step 124); otherwise the message is appended to the associated TDR (step 128, FIG. 5B).

Step 130: The UDP destination and source port numbers are examined and if either corresponds to the established port for mobile IP (port no. 434) then the message is passed to step 132 for further processing. If the UDP destination or source port corresponds to the established port for RADIUS (port no. 1812 for authorisation or 1813 for accounting) then the message is passed to step 126 for further processing (i.e. adding data obtained from the AAA 22 to the TDR—step 128). Any UDP message that has a source or destination port that does not correspond to these established values is discarded (step 134). Port numbers are assigned by IANA, and published at http://www.iana.org/assignments/port-numbers.

Occasionally the port numbers in the service provider's network may be changed (or additional ports used) for operational reasons, so implementation of the invention is enhanced by enabling the RADIUS and mobile IP port numbers to be configurable during operation.

Steps 132/136: The message at this point has been identified as a mobile IP registration and as it is present in a CDMA 2000 network it will contain a service specific extension (SSE) information element as defined in the A11 specification identified above (section 4.2.12). If an association is present for the (PCF/PT/KEY) triple then a further check is made to see if the IMSI in the association is the same as the IMSI in the SSE (step 136). If either of these tests fails then a new association is made at step 138; this step thus has the effect of de-multiplexing the different signalling sessions according to the SSE information elements. Otherwise processing proceeds at step 140.

Step 138: The IMSI (MS ID), PT and Key are extracted from the SSE and an association is created between the PCF address (extracted in step 110), the PT, the Key and the IMSI. The A10 state is initialised to ‘new’.

Step 140: If there is no association between the IMSI and a TDR reference then a new TDR is created and associated with the IMSI (step 164, FIG. 5B).

Steps 142/146, FIG. 5B: If there is an association between the IMSI and a TDR reference, then the A11 message type field (section 4.2.1 of the above-identified 3GPP2 document) is extracted and if it corresponds to an A11-Registration-Request the message is passed to step 144 for further processing. If the message type corresponds to an A11-Registration-Update (tested at step 146) then the message is passed to step 148 for further processing. All other message types are appended to the TDR (step 128).

Steps 144/150/152: If the A10 connection is in the released state (rel) and the lifetime field is non-zero (as tested at step 150), or the A10 connection state was initialised to new (step 144), then a new connection is being established and processing proceeds at step 152; but if the A10 connection is in the released state (rel) and the lifetime field is zero, the message is appended to the TDR (step 128). If the A10 connection is in the connected state (conn) and the lifetime field is zero (as tested at step 154) then a connection is being released and processing proceeds at step 156; otherwise the message is appended to the TDR (step 128).

Step 148: If the A10 connection is in the connected (conn) or new state then the connection is being released and processing proceeds at step 156; otherwise the message is appended to the TDR (step 128).

Steps 156/158/160/162: When an A10 connection is released the A10 state is changed to released (rel, step 156) and an A10 connection counter (A10 CC) established at step 166 (described below) is decremented (step 158). If there are no A10 connections associated with the IMSI the A10 connection counter will be zero (step 160) and an expiry timer is started for the TDR (step 162). In either case the message is appended to the TDR (step 128). The timer is set to a value large enough to capture any acknowledgements and on its expiration downstream application software is notified that a TDR is available for processing. There is no danger of transactions merging together while a timer is running because steps 142, 144 and 152 ensure that a new transaction is uniquely identified.

Steps 152/166/168: When a new A10 connection is established the A10 connection count is tested (step 152). If the A10 CC is zero then this is a new transaction; a new TDR is created (step 164) and the reference count is set to 1 to indicate that one A10 connection is currently established (step 166). If the A10 CC is greater than 0 then a new A10 connection is being created for a transaction currently in progress (this occurs during a handover); the count is incremented to represent the number of currently established A10 connections (step 168). In all cases the A10 state is set to connected (conn, step 170) and the message is appended to the TDR (step 128).

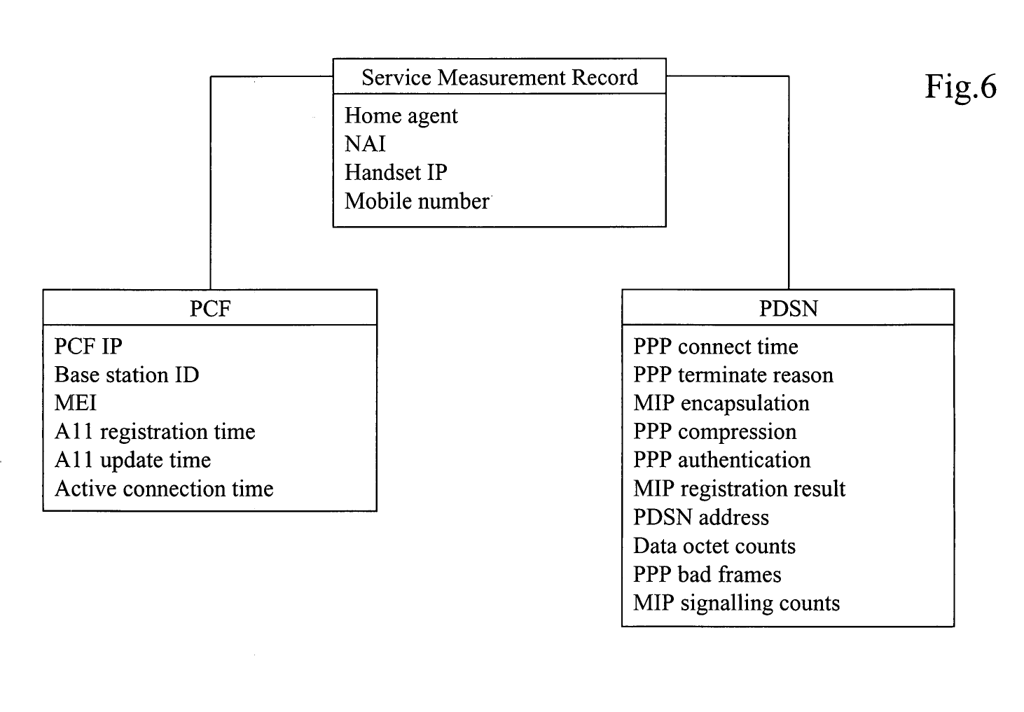

The result of this procedure is a sequence of TDRs each summarising the significant information pertaining to CDMA 2000 mobile IP transactions, as illustrated in FIG. 6. Downstream application software can use these TDRs for various purposes, such as monitoring QoS levels as experienced by users, detecting failures to meet contracted levels of QoS (so that problems can be rectified), and validating billing for services provided.

Although the above description has been presented for convenience in the context of a CDMA 2000 system, the invention is also applicable to other protocols for supporting mobile data communications.

1. A method of assembling a transaction detail record for a mobile data service, provision of said service involving a communications path carrying at least one signalling channel and a plurality of data channels, and also involving a resource for providing at least one of authentication, authorisation and accounting, comprising:
de-multiplexing signalling sessions carried on said signalling channel and selecting a signalling session related to a mobile data service;
using information from the selected signalling session to identify data sessions associated with the mobile data service;
using information from the selected signalling session to obtain information related to the mobile data service from the resource; and
assembling information relating to the identified data sessions and information obtained from the resource to provide a transaction detail record.

2. The method of claim 1, wherein the signalling sessions are de-multiplexed by reference to service specific extension information.

3. The method of claim 1, wherein the information used to identify data sessions associated with the mobile data service is a combination of Packet Control Function node IP address, Generic Routing Encapsulation (GRE) protocol-type field and GRE protocol key.

4. The method of claim 1, wherein the information used to obtain information related to the mobile data service from the resource is an International Mobile Subscriber Identity.

5. The method of claim 1, wherein information relating to the identified data sessions and information obtained from the resource are assembled to provide a transaction detail record by reference to an association of Packet Control Function node IP address, Generic Routing Encapsulation (GRE) protocol-type field and GRE protocol key with an International Mobile Subscriber Identity and a connection counter.

6. The method of claim 1, wherein the mobile data service is provided in a CDMA 2000 system.

7. Apparatus for assembling a transaction detail record for a mobile data service, provision of said service involving a communications path carrying at least one signalling channel and a plurality of data channels, and also involving a resource for providing at least one of authentication, authorisation and accounting, comprising:
a de-multiplexer for de-multiplexing signalling sessions carried on said signalling channel and selecting a signalling session related to a mobile data service;
a session identifier for using information from the selected signalling session to identify data sessions associated with the mobile data service;
a resource query means for using information from the selected signalling session to obtain information related to the mobile data service from the resource; and
an assembler for assembling information relating to the identified data sessions and information obtained from the resource to provide a transaction detail record.

8. The apparatus of claim 7, wherein the de-multiplexer de-multiplexes signalling sessions by reference to service specific extension information.

9. The apparatus of claim 7, wherein the information used to identify data sessions associated with the mobile data service is a combination of Packet Control Function node IP address, Generic Routing Encapsulation (GRE) protocol-type field and GRE protocol key.

10. The apparatus of claim 7, wherein the information used to obtain information related to the mobile data service from the resource is an International Mobile Subscriber Identity.

11. The apparatus of claim 7, wherein the assembler assembles information relating to the identified data sessions and information obtained from the resource to provide a transaction detail record by reference to an association of Packet Control Function node IP address, Generic Routing Encapsulation (GRE) protocol-type field and GRE protocol key with an International Mobile Subscriber Identity and a connection counter.

12. The apparatus of claim 7, wherein the mobile data service is provided in a CDMA 2000 system.
